(19) United States
(12) Patent Application Publication
(10) Pub. No.: US 2002/0018247 A1
(43) Pub. Date: Feb. 14, 2002

(54) Image processing apparatus and processing method therefor

(76) Inventor: Mitsugu Hanabusa, Tokyo (JP)

Correspondence Address: MORGAN & FINNEGAN, L.L.P., 345 PARK AVENUE, NEW YORK, NY, 10154, US

(21) Appl. No.: 09/892,076

(22) Filed: Jun. 26, 2001

(30) Foreign Application Priority Data
Jun. 27, 2000 (JP) 193376/2000
Jun. 21, 2001 (JP) 188236/2001

(51) Int. Cl. H04N 1/04

(52) U.S. Cl. 358/474

(57) ABSTRACT

In order to provide an image processing apparatus which can satisfy both requirements for the balance between a storage time in a high-resolution mode and that in a low-resolution mode and high-speed reading operation in the low-resolution mode, the image processing apparatus of this invention includes an image sensing unit which includes a first element array having a plurality of photoelectric conversion elements arranged in a line, and a second element array shifted from the first element array by a predetermined distance in a main scanning direction and having a plurality of photoelectric conversion elements arranged in a line, and outputs signals of the first and second element arrays from a single output portion, and a driving unit having a first mode of reading signals from the second element array and continuously outputting the signals from the output portion, and a second mode of reading signals from the first element array and continuously outputting the signals from the output portion.

### FIELD OF THE INVENTION

The present invention relates to an image processing apparatus for reading an image signal and outputting it and a processing method for the apparatus.

### BACKGROUND OF THE INVENTION

An image reader, which scans an original in the main scanning direction with a line image sensor (to be referred to as a CCD hereinafter), and at the same time, relatively scans the CCD or the original in the sub-scanning direction (a direction perpendicular to the CCD element arrays), thereby obtaining two-dimensional image information, is known. An example of this type of image reader uses a technique of improving the image read resolution by increasing the number of CCD elements and arranging them in a staggered pattern (refer to Japanese Patent Laid-Open No. 57-141178, Japanese Patent Publication No. 59-6666, and the like).

The arrangement and operation of a standard scanner using a CCD having a staggered pattern will be described with reference to FIGS. 14 to 20. FIGS. 14A and 14B show a flat bed scanner and, more specifically, an example of an arrangement for reading a reflected original. FIG. 14A is a plan view of the scanner. FIG. 14B is a side view of the scanner. Reference symbol D denotes an original to be read which is placed on an original glass table 100. A light source 101 irradiates the original D with light. The resultant reflected light is reflected by mirrors 102, 103, and 104 and formed into an image on a CCD 106 through a lens 105. A read unit 107 on which the light source 101, mirrors 102, 103, and 104, lens 105, and CCD 106 are fixed is scanned (sub-scanned) parallel to the original glass table 100 from the left to the right in FIG. 14A to read the entire original D, thereby obtaining a 1-page image signal from the CCD 106. A CCD board 113 on which the CCD 106 is mounted is connected to a main board 112 fixed to the image reader through a cable 111. As shown in FIG. 14A, the downward direction is the main scanning direction, and the leftward direction is the sub-scanning direction. This scanner is covered with an outer cover 109 and original press member 110 to shield the original against external light.

FIG. 15 is a block diagram showing control on the operation of the image reader. The electrical signal obtained by photoelectric conversion using the CCD 106 is subjected to gain control in an analog processing circuit 201 including a sample/hold circuit (S/H circuit) such as a CDS (Correlated Double Sampling circuit). The resultant signal is then digitized by an A/D converter 202. Reference numeral 204 denotes a shading RAM (Random Access Memory) for storing the light distribution characteristics of the optical system; and 205, an signal processing circuit comprised of a circuit for controlling the shading RAM 204 storing shading correction coefficients and a circuit for controlling enlargement and reduction of image data, i.e., a control circuit for an offset RAM 240 for image read and write. Shading correction is performed by the shading RAM 204. The correction data generated on the basis of shading data obtained by reading a main scanning white reference plate 108 prior to image reading operation is stored in the shading RAM 204. The signal processing circuit 205 using the offset RAM 240, performs not only correction of R, G, and B line offsets but also thinning processing and interpolation processing on the basis of the read image data in magnifying (reducing/enlarging) operation.

Reference numeral 206 denotes a binarizing circuit for binarizing an image signal; and 207, an interface circuit for receiving control signals from a external unit 250 such as a personal computer and outputting image signals.

Reference numeral 208 denotes a CPU (Central Processing Unit) in the form of a microcomputer having a ROM 208A storing a control program and a RAM 208B serving as a work area. The CPU 208 controls the respective components in accordance with the control program stored in the ROM 208A. Reference numeral 209 denotes a timing signal generating circuit for frequency-dividing an output from a quartz oscillator 210 in accordance with the setting in the CPU 208 and generating various types of timing signals.

FIG. 16 shows the arrangement of a color CCD having a staggered element pattern in which two arrays of photodiodes as photoelectric conversion elements are arranged for each color, and the elements are shifted from each other by ½ the element length (to be referred to as ½P hereinafter) in a staggered pattern. FIG. 17 shows the relationship between photodiodes, shift registers, and first and second transfer clocks (φ1, φ2) for one of R, G, and B.

As shown in FIGS. 16 and 17, two arrays of photodiodes 5a and 6a are spaced from each other by a distance corresponding to n lines in a sub scanning direction. Image data in the respective element arrays are transferred to shift registers 5c and 6c through shift gates 5b and 6b in accordance with shift pulses SH-r (7). The image data transferred to the shift registers 5c and 6c are sequentially input to an output buffer in accordance with first and second transfer clocks. In this case, the image data from the photodiodes 5a and 6a are alternately and sequentially transferred to the output buffer, and output from a CCD output OS-r2 in response to each reset clock RS5. The same applies to G and B.

The image data transferred to the output buffer are output from CCD outputs OS-g3 and OS-b4 for each reset pulse RS in accordance with the first and second transfer clocks. As a result, as CCD outputs OS-r2, OS-g3, and OS-b4, image data shifted from each other by N lines are output.

FIG. 18 shows an example of the drive timing of the CCD 106 and analog processing circuit 201. FIG. 18 shows the CCD drive timings of φ1(10), φ2(11), and RS(5), the CCD outputs OS-r2, OS-g3, and OS-b4, an S/H pulse signal in the analog processing circuit for processing the image signals, and the input timing with respect to the A/D converter 202.

The CCD operation defined by the timings of the transfer clocks φ1(10) and φ2(11) and reset pulse RS(5) will be described with reference to FIGS. 19 and 20. Image data is transferred to a floating capacitor in accordance with the transfer clocks φ1(10) and φ2(11) for driving a transfer electrode and converted into a voltage signal to be output as a signal output OS. At timing Tc1, in FIG. 19, the potential wells of the odd-numbered element array shift register having, image data S2n+1, S2n+3, . . . are sequentially transferred, as shown in FIG. 20. In a state immediately after the reset gate has shifted from the ON state to the OFF state by a reset pulse, no image data is present in the floating capacitor. At timing Tc2, the potential wells in the odd-numbered element array shift register having, the image data S2n+1 is transferred to the floating capacitor. At timing Tc3, the reset gate is turned on by a reset pulse, and the image data S2n+1 in the floating capacitor is reset. In this manner, image data are alternately transferred from the respective shift registers of the odd- and even-numbered element arrays to the floating capacitor, and the data from the signal output OS is updated by a reset pulse.

At a low resolution equal to or less than ½ a basic resolution, data is read from one element array in FIG. 16, as shown in FIG. 21. In this case, the maximum operation frequency of φ1 and φ2 is doubled to match the write speed of the RAM with that of the basic resolution, and image data read out after being thinned out by the analog processing circuit 201 (Japanese Patent Laid-Open No. 8-9143). Immediately after a signal is output from each shift register to the output buffer, the output buffer is reset, resulting in a great decrease in CCD output interval. This makes it very difficult to ensure linearity of image data. According to the arrangement of this image reader and the driving method for the reader, the storage time of the low-resolution mode becomes ½ that of the high-resolution mode. If, therefore, the storage time remains unchanged, the read speed of the low-resolution mode must be decreased. That is, it is difficult to make the storage time of the high-resolution mode equal to that of the low-resolution mode and realize high-speed reading operation in the low-resolution mode.

### SUMMARY OF THE INVENTION

It is an object of the present invention to provide an image processing apparatus and processing method therefor, which can satisfy both the requirements for the balance between the storage time in the high-resolution mode and that in the low-resolution mode and high-speed reading operation in the low-resolution mode.

According to the present invention, the foregoing object is attained by providing an image processing apparatus comprising: image sensing means which includes a first element array having a plurality of photoelectric conversion elements arranged in a line, and a second element array shifted from the first element array by a predetermined distance in a main scanning direction and having a plurality of photoelectric conversion elements arranged in a line, and outputs signals of the first and second element arrays from a single output portion; and driving means having a first mode of reading signals from the second element array and continuously outputting the signals from the output portion, and a second mode of reading signals from the first element array and continuously outputting the signals from the output portion.

According to another aspect of the present invention, the foregoing object is attained by providing an image processing apparatus comprising: image sensing means which includes a first element array having a plurality of photoelectric conversion elements arranged in a line, and a second element array shifted from the first element array by a predetermined distance in a main scanning direction and having a plurality of photoelectric conversion elements arranged in a line, and outputs signals of the first and second element arrays from a single output portion; and driving means for outputting signals from one of the first and second element arrays and resetting signals from the other element array in the output portion.

In still another aspect of the present invention, the foregoing object is attained by providing an image processing apparatus comprising: a first element array having a plurality of photoelectric conversion elements arranged in a line; a second element array shifted from the first element array by a predetermined distance in a main scanning direction and having a plurality of photoelectric conversion elements arranged in a line; a first shift register for transferring signals from the first element array; a second shift register for transferring signals from the second element array; and an input unit for receiving at least three pulses having different phases and supplying the pulses to the first and second shift registers.

In still another aspect of the present invention, the foregoing object is attained by providing a processing method for an image processing apparatus including a first element array having a plurality of photoelectric conversion elements arranged in a line, a second element array shifted from the first element array by a predetermined distance in a main scanning direction and having a plurality of photoelectric conversion elements arranged in a line, and output means for outputting signals of the first and second element arrays from a single output portion, comprising the step of reading signals from the second element array and continuously outputting the signals from the output portion or reading signals from the first element array and continuously outputting the signals from the output portion.

In still another aspect of the present invention, the foregoing object is attained by providing a processing method for an image processing apparatus including a first element array having a plurality of photoelectric conversion elements arranged in a line, a second element array shifted from the first element array by a predetermined distance in a main scanning direction and having a plurality of photoelectric conversion elements arranged in a line, and output means for outputting signals of the first and second element arrays from a single output portion, comprising the step of outputting signals sent from one of the first and second element arrays from the output portion, and resetting signals from the other element array in the output portion.

In still another aspect of the present invention, the foregoing object is attained by providing a processing method for an image processing apparatus including a first element array having a plurality of photoelectric conversion elements arranged in a line, and a second element array shifted from the first element array by a predetermined distance in a main scanning direction and having a plurality of photoelectric conversion elements arranged in a line, comprising the step of transferring signals from the first and second element arrays in accordance with at least three pulses.

Other features and advantages of the present invention will be apparent from the following description taken in conjunction with the accompanying drawings, in which like reference characters designate the same or similar parts throughout the figures

### BRIEF DESCRIPTION OF THE DRAWINGS

FIG. 1 is a timing chart showing CCD driving operation for reading out data from only an odd-numbered element array of the first embodiment;

FIG. 2 is a timing chart showing CCD driving operation for reading data from only an even-numbered element array of the first embodiment;

FIG. 3 is a timing chart showing CCD driving operation in a basic resolution mode to explain the first embodiment;

FIG. 4 is a timing chart showing CCD driving operation in a basic resolution mode of the prior art compared with the first embodiment;

FIG. 5 is a timing chart showing CCD driving operation in a low-resolution mode to explain the first embodiment;

FIG. 6 is a view showing read image areas in the basic resolution mode to explain the first embodiment;

FIG. 7 is a block diagram showing the internal structure of a CCD to explain the second embodiment of the present invention;

FIG. 8 is a schematic diagram of photodiode portions and shift register portions in the CCD in FIG. 7;

FIG. 9 is a timing chart for explaining CCD driving operation using the arrangement in FIG. 7;

FIG. 10 is a view for explaining operation in the CCD at the CCD driving timing in FIG. 9;

FIG. 11 is a timing chart for explaining CCD driving operation using the arrangement in FIG. 7;

FIG. 12 is a timing chart for explaining another CCD driving operation using the arrangement in FIG. 7;

FIG. 13 is a timing chart for explaining still another CCD driving operation using the arrangement in FIG. 7;

FIGS. 14A and 14B are schematic views of an image reader;

FIG. 15 is a block diagram of a circuit for controlling the image reader;

FIG. 16 is a block diagram showing the internal structure of a CCD to explain the prior art;

FIG. 17 is a wiring diagram of photodiode portions and shift register portions in the CCD in FIG. 16;

FIG. 18 is a view for explaining an example of a conventional CCD element array;

FIG. 19 is a timing chart showing CCD driving operation to explain the prior art;

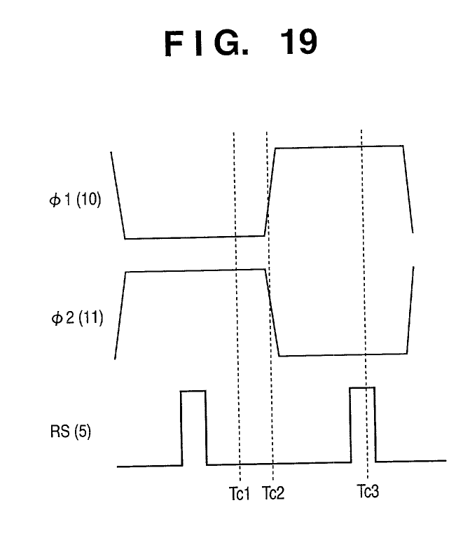

FIG. 20 is a view for explaining operation in the CCD at a CCD driving timing according to the prior art; and

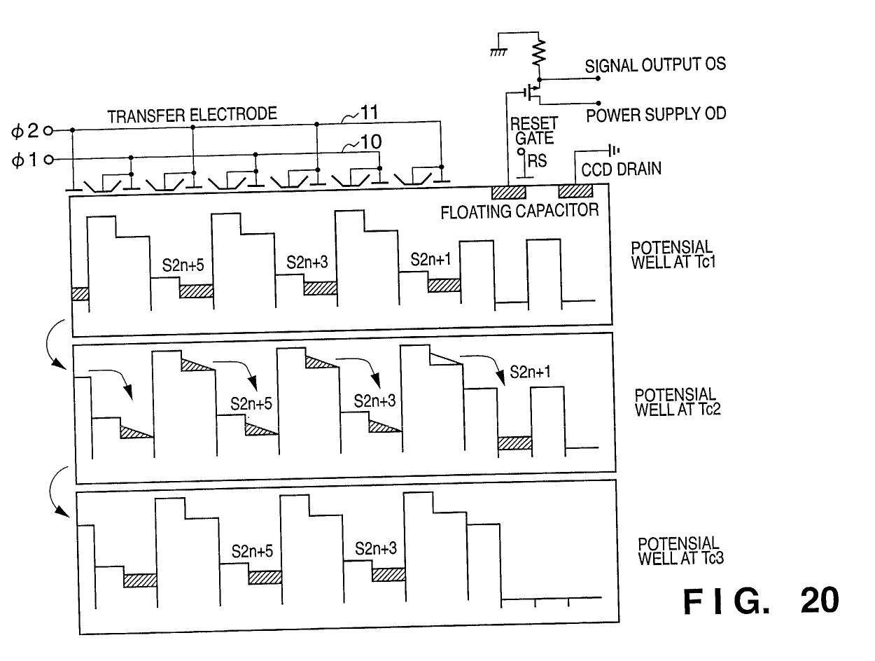

FIG. 21 is a timing chart showing CCD driving operation with a resolution ½ the basic resolution to explain the prior art.

### DETAILED DESCRIPTION OF THE PREFERRED EMBODIMENTS

Embodiments of the present invention will be described below with reference to the accompanying drawings.

(First Embodiment)

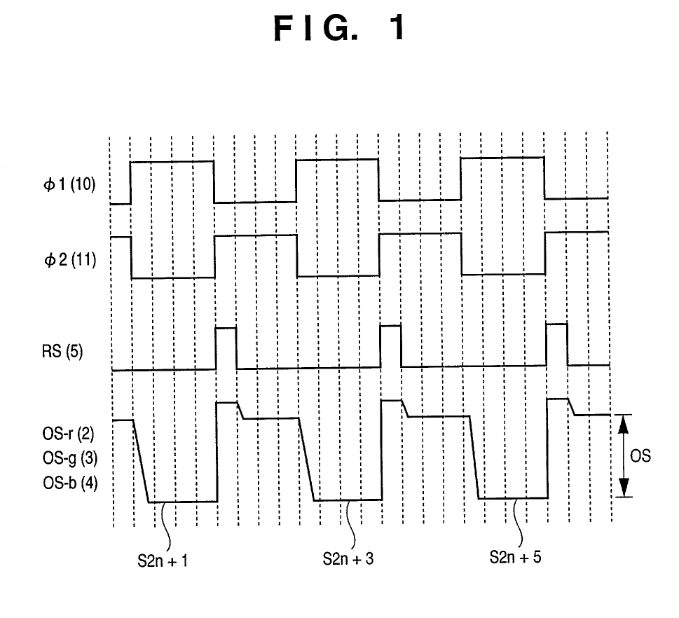

A scanner according to the first embodiment of the present invention will be described with reference to FIGS. 1 to 4.

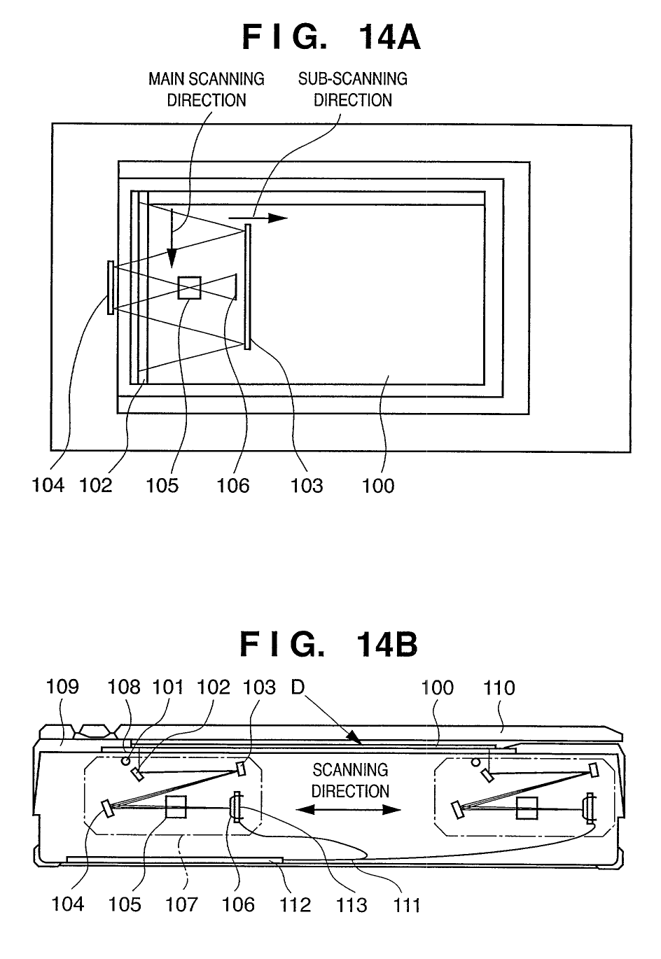

Since the mechanical and electrical arrangements of the scanner according to this embodiment are the same as those shown in FIGS. 14 to 17, a description thereof will be omitted.

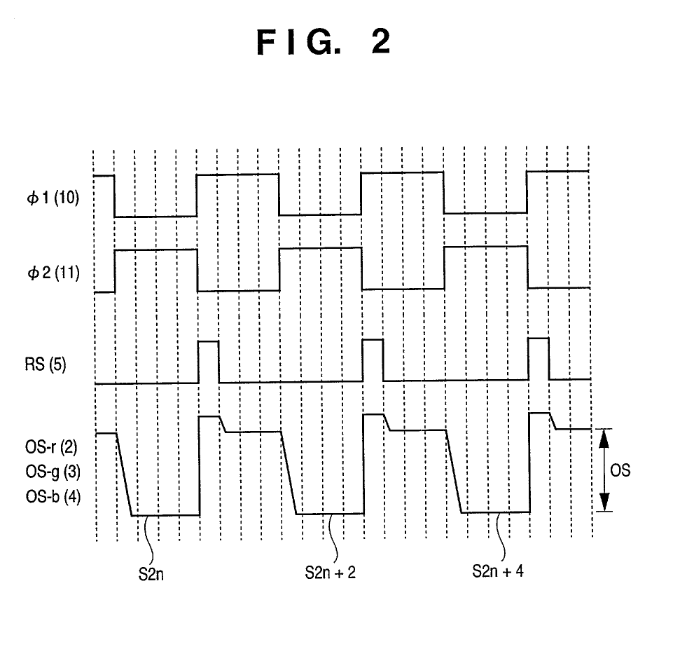

FIGS. 1 and 2 are timing charts showing transfer clocks φ1 and φ2 and reset clock RS according to this embodiment, and an output signal OS-r (OS-g and OS-b) as the result obtained by driving shift registers using these clocks.

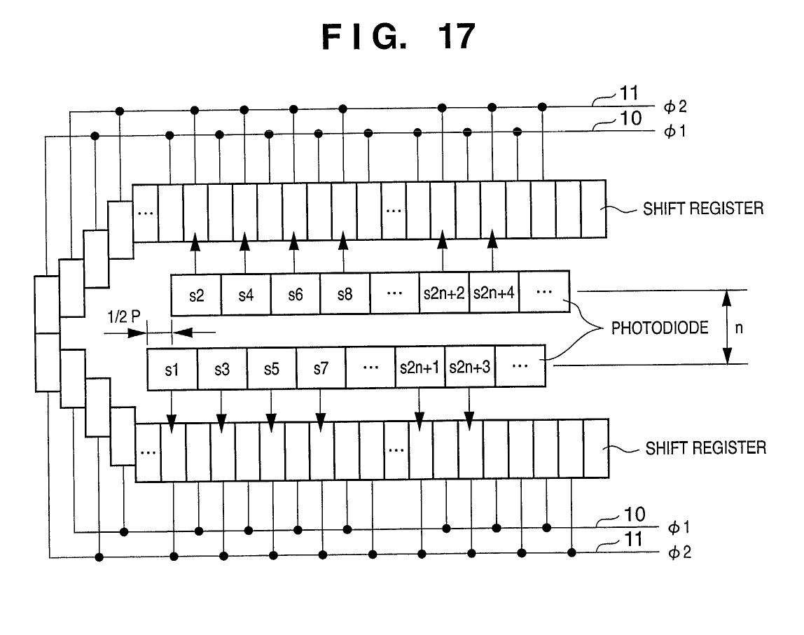

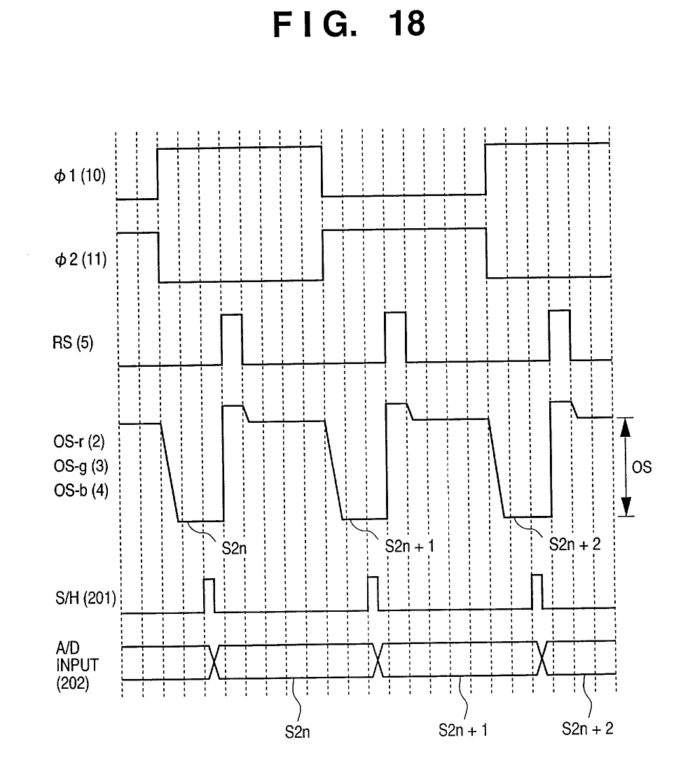

FIG. 1 will be described first. Referring to FIG. 1, like FIG. 18, the transfer clocks φ1 and φ2 have opposite phases. At the leading edge of the clock φ1, image data in the odd-numbered elements (image data stored in the lower shift register in FIG. 17) is outputted to the output buffer. At the trailing edge of the clock φ1, image data in the even-numbered elements (image data in the upper shift register in FIG. 17) is outputted to the output buffer.

The reset clock RS goes HIGH at the instant when φ1= LOW and φ2= HIGH. With this operation, the image data in the even-numbered elements is reset at the same time it is outputted to the output buffer, and hence is not output from the CCD. As a consequence, as indicated by the lowermost level in FIG. 1, only the image data from the odd-numbered elements are output from the CCD.

In contrast to this, in the case shown in FIG. 2, the reset clock RS goes HIGH at the instant when φ1= HIGH and φ2= LOW. With this operation, the image data from the odd-numbered elements are reset at the same time it is outputted from the shift register to the output buffer, and hence is not outputted from the CCD. As a consequence, as indicated by the lowermost level in FIG. 2, only the image data from the even-numbered elements is outputted from the CCD.

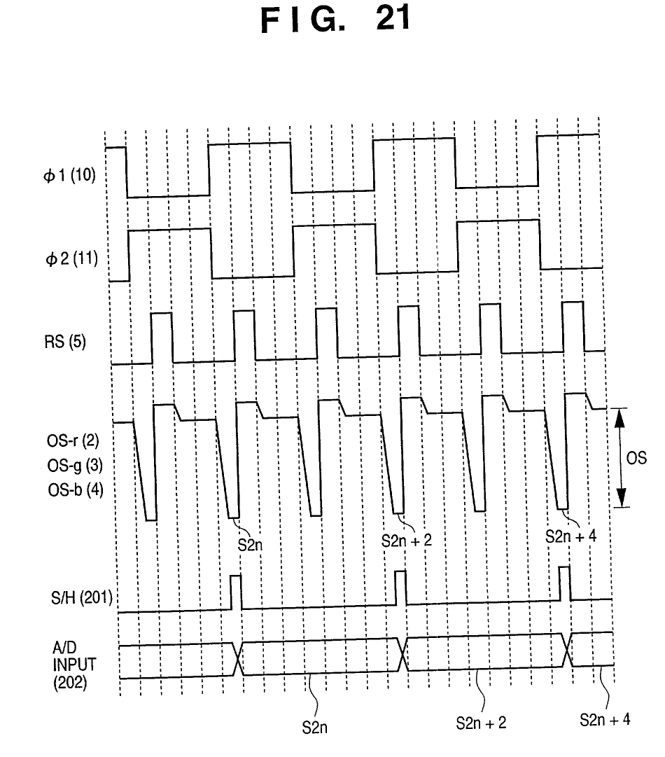

As shown in FIGS. 1 and 2, the CCD can selectively output only the image data read by either the odd or even photodiode arrays. And then, even if the frequencies of the transfer clocks φ1 and φ2 and reset clock RS are increased twice those in the prior art, sufficient output time can be ensured for image data in each element which is outputted from the output buffer. More specifically, as compared with the case shown in FIG. 21 in which image in all the elements are outputted from the CCD and thinned out by the S/H circuit, with the operation shown in FIGS. 1 and 2, the interval between the instant at which image data is outputted from the shift register to the output buffer and the instant at which the image data is reset is long, and hence the precision of outputting data from the CCD (output buffer) improves.

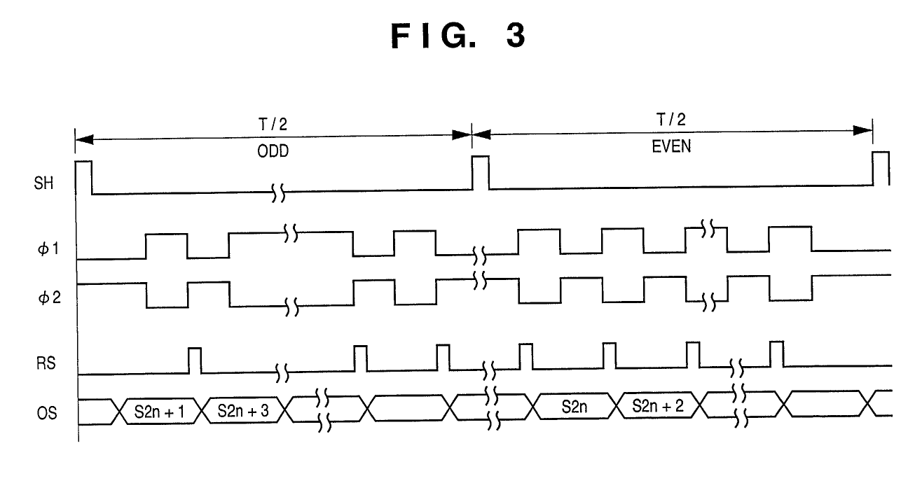

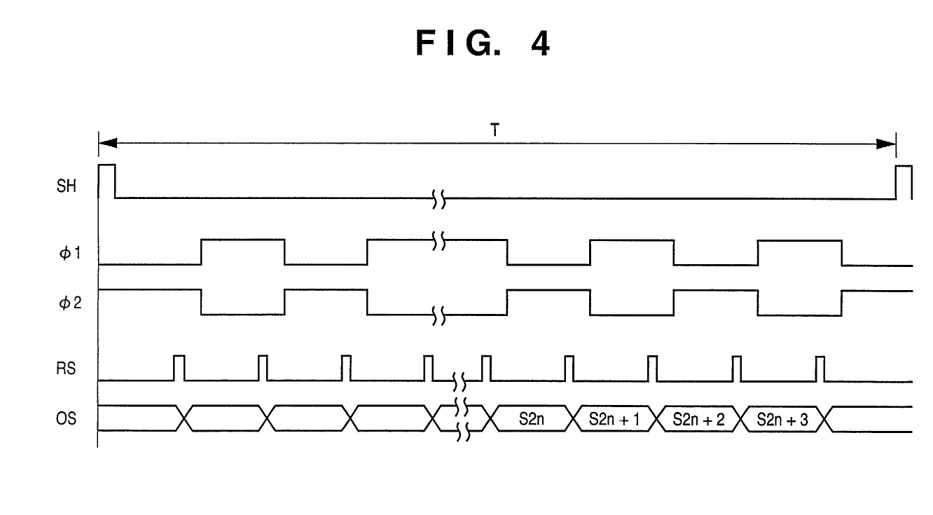

FIG. 3 is a timing chart showing a case where an image is read in a high-resolution mode by driving the respective clocks at the timings shown in FIGS. 1 and 2. In this embodiment, as shown in FIG. 3, first, the respective clocks are driven as shown in FIG. 1 to continuously output only the image data in the odd-numbered element array of the CCD to the memory. The respective clocks are then driven as shown in FIG. 2 to continuously output the image data in the even-numbered element array to the memory. FIG. 4 is a timing chart showing how data is read by driving the respective clocks in the prior art. “T” in FIG. 4 indicates the time required to output image data from the CCD to the memory from all the elements arranged in a staggered pattern. Referring to FIG. 3, the frequencies of the respective clocks are increased to twice those in the prior art to output from the CCD, the image data in the odd-numbered elements, in the time interval of T/2, and output the image data from the CCD in the even-numbered elements in the next time interval of T/2. In the high-resolution mode, therefore, the data in all the photoelectric conversion elements of the two arrays can be outputted in the same period of time as that in the prior art. Even if a limitation is imposed on the DRAM access time on the digital circuit, and the same CCD output timing as that of the prior art is required, data can be read in a storage time ½ of that of the prior art.

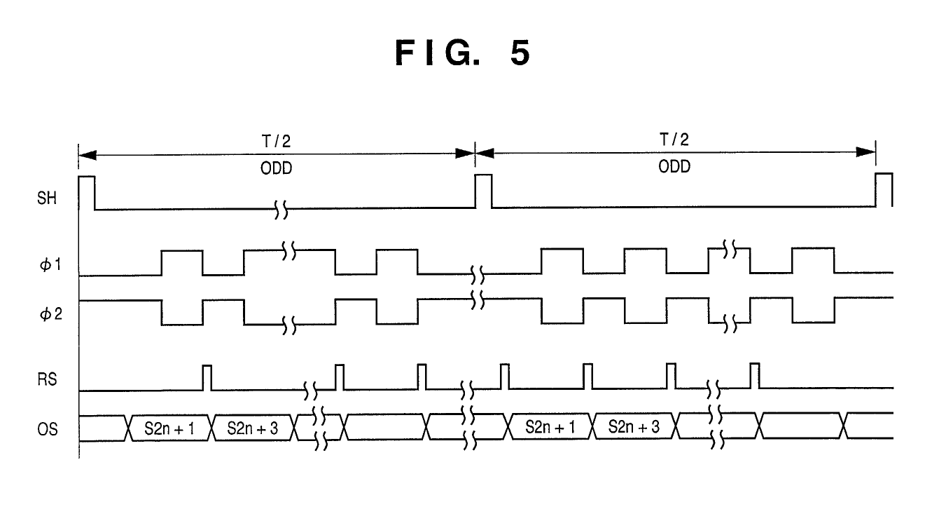

FIG. 5 is a timing chart showing how an image is read in a low-resolution mode of this embodiment. In this embodiment, in the low-resolution mode, the respective clocks are always driven as shown in FIG. 1 to output only the image data in the odd-numbered elements from the CCD. Obviously, the present invention is not limited to this, and the respective clocks may always be driven as shown in FIG. 2 to output from the CCD only the image data in the even-numbered elements. In addition, in the low-resolution mode, since the CCE) moves in the sub-scanning direction at a speed twice that of the high-resolution mode, data can be read at high speed.

Furthermore, since the frequencies of the respective clocks remain the same in the high-resolution mode and low-resolution mode, the storage time also remains the same.

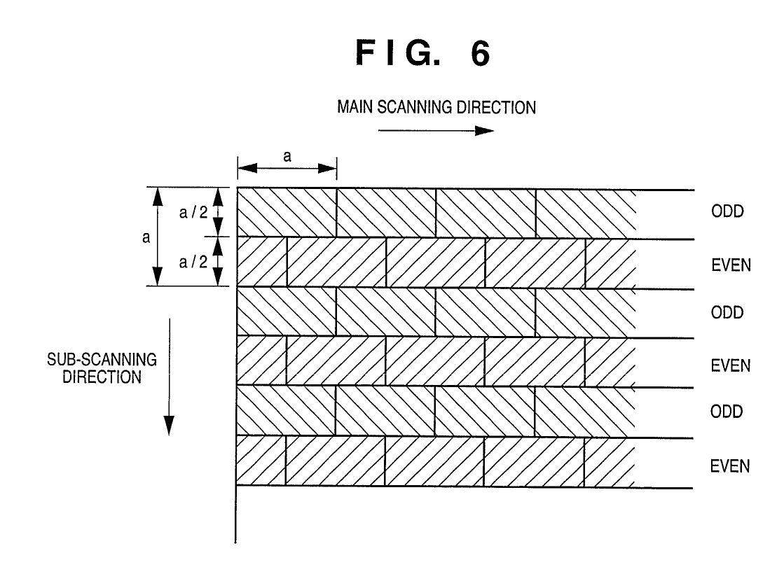

If a distance between the odd and even photodiode arrays comprising a×a photodiodes is set to an odd multiple of a/2, and the CCD is driven in the same manner as in this embodiment, read areas like those shown in FIG. 6 can be obtained.

According to the arrangement of the image reader using the CCD having a staggered pattern according to this embodiment and the driving method for the image reader, data can be read from either the odd-numbered element array or even-numbered element array in the staggered pattern, and element addition is allowed in the shift register unit to read data from the CCD in ½ the storage time of the prior art in the basic resolution (high-resolution) mode. In the mode of reading data with a resolution ½ that of the basic resolution mode, data can be read in the same storage time as that of the basic resolution mode. Therefore, the same original can be read in a time ½ the read time of the basic resolution mode.

Therefore, both the requirements for the balance between the storage time in the high-resolution mode and that in the low-resolution mode and high-speed reading operation in the low-resolution mode can be satisfied.

(Second Embodiment)

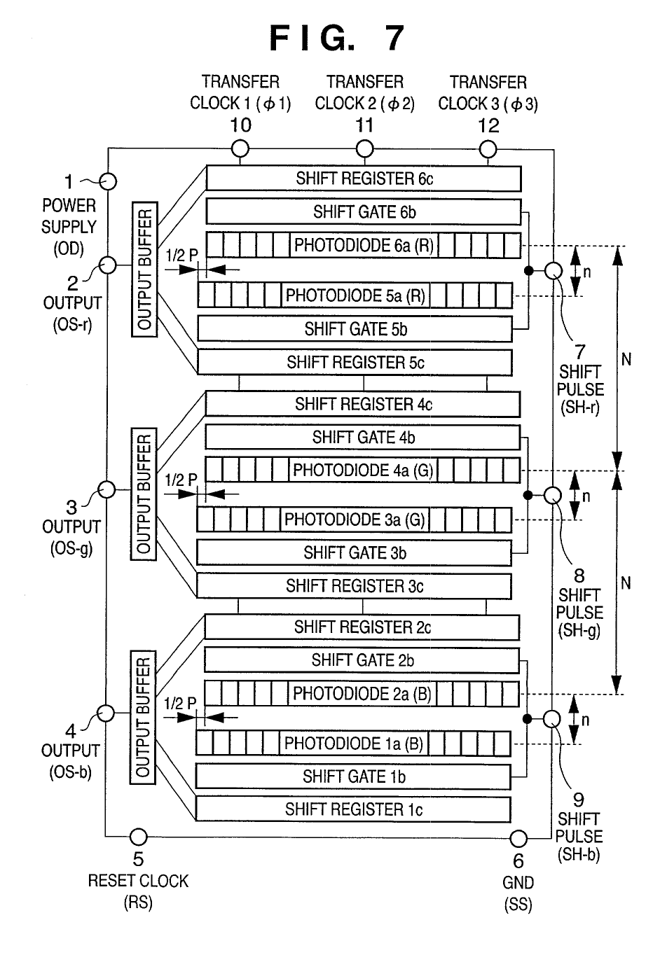

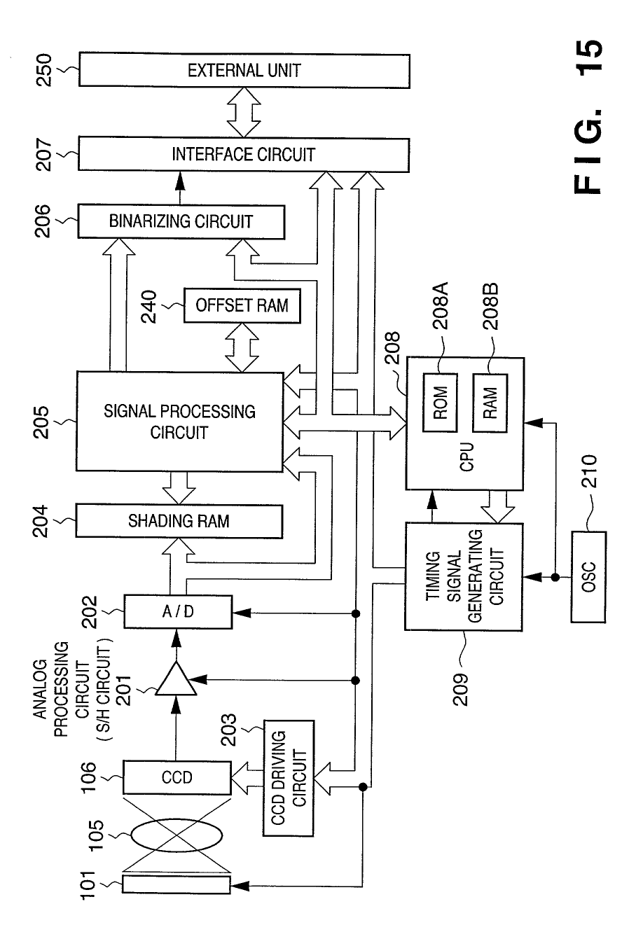

A scanner according to the second embodiment of the present invention will be described next with reference to FIGS. 7 to 13. The mechanical arrangement of the scanner according to this embodiment is the same as that shown in FIGS. 14 and 15, and hence a description thereof will be omitted.

FIG. 7 is a view showing the CCD arrangement according to the second embodiment in the image processing apparatus according to the present invention.

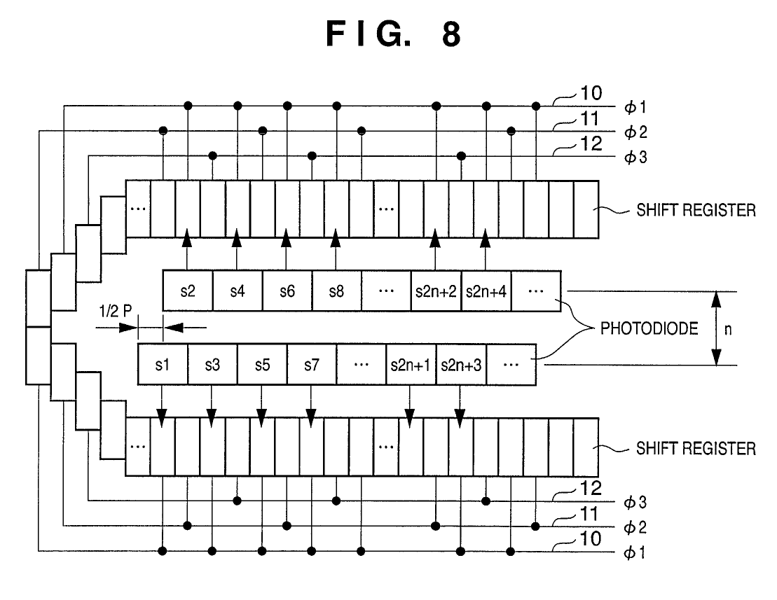

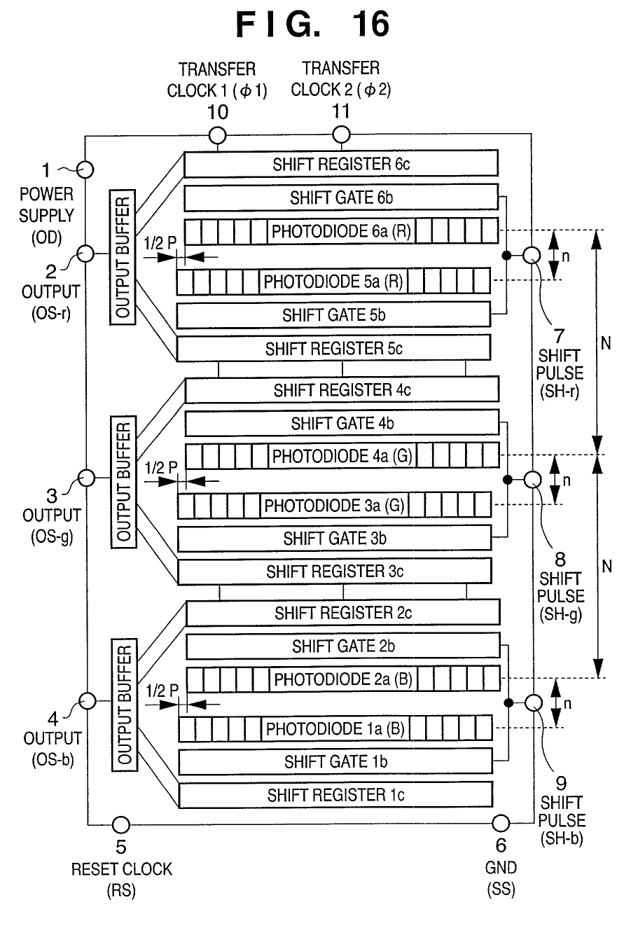

Like FIG. 16, FIG. 7 shows the arrangement of the color CCD having a staggered arrangement in which two arrays of photodiodes are arranged for each color, and the respective elements are shifted from each other by ½ the element length in a staggered pattern. This scanner has a first transfer clock 10 (φ1), second transfer clock 11 (φ2), and third transfer clock 12 (φ3). FIG. 8 is a view showing the relationship between the photodiodes, shift registers, first transfer clock (φ1), second transfer clock (φ2), and third transfer clock (φ3) for one color of R, G, and B. The number of shift registers is twice or more that of photodiodes.

Referring to FIG. 7, in the photosensitive portion for R, photodiode arrays 5a and 6a are arranged at a distance n from each other. Image data in the respective element arrays are transferred to shift registers 5c and 6c through shift gates 5b and 6b in accordance with shift pulses SH-r (7). The image data transferred to the shift registers 5c and 6c are sequentially transferred in response to the first, second, and third transfer clocks φ1, φ2, and φ3. The image data is alternately and sequentially inputted from the photodiode arrays 5a and 6a to the output buffer. The arrangements and operations of the photosensitive portions for G and B are the same as those described above for R. Since these photosensitive portions are spaced apart from each other by N lines as shown in FIG. 7, image data shifted from each other by N lines are output as CCD outputs OS-r (2), OS-g (3), and OS-b (4).

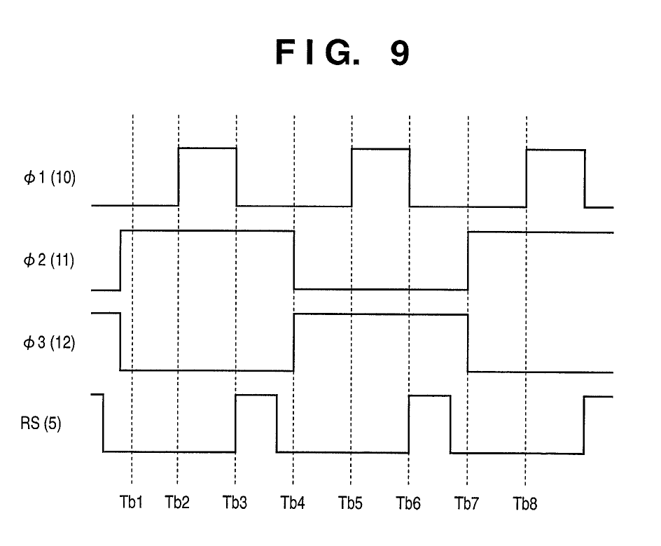

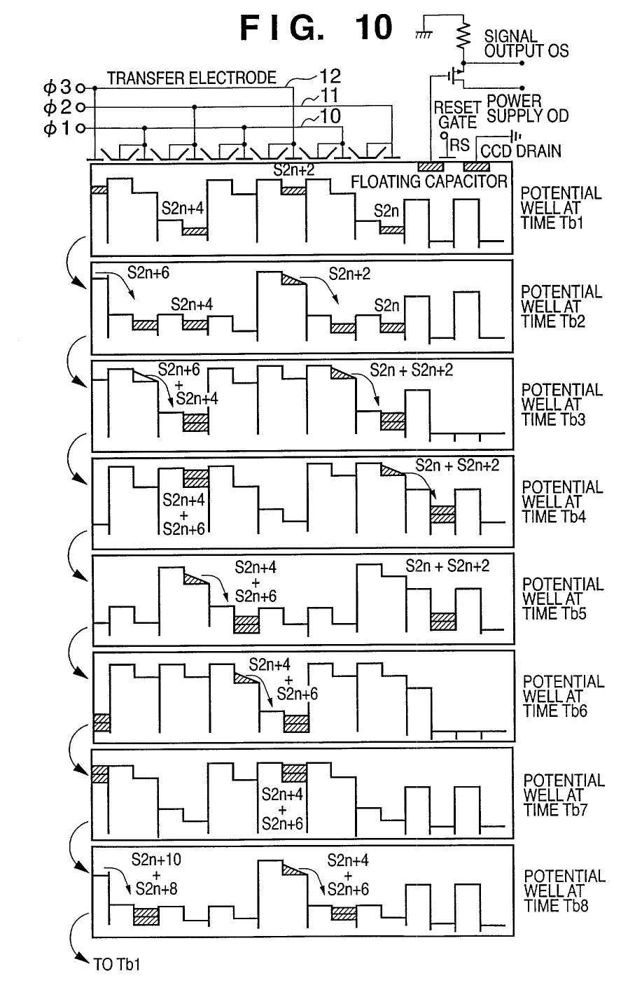

A method of reading image information with a resolution ¼ or less than the basic resolution of the scanner using the CCD shown in FIGS. 7 and 8 will be described with reference to FIGS. 9 and 10.

FIG. 9 is a timing chart for explaining the timings of the transfer clocks φ1, φ2, and φ3 and a reset pulse RS in this embodiment. In the embodiment, the frequency of the transfer clock 41 is set to be twice that of each of the transfer clocks φ2 and φ3, and the image data in the odd-numbered element array is reset by the reset pulse RS to be discarded.

FIG. 10 is a view showing the states of potential wells and data transfer at each timing in FIG. 9. In the shift register for the even-numbered element array, at timing Tb1 in FIG. 9, image data S2n, S2n+2, . . . before element addition in the shift register portion, are secured in the potential wells, as indicated by the uppermost level in FIG. 10. Since the reset gate has been turned on by a reset pulse immediately before this state, no image data exists in the floating capacitor.

At a timing Tb2, the transfer clock φ1 goes HIGH to transfer image data S2n+2, S2n+6, and S2n+10 without transferring image data S2n, S2n+4, and S2n+8. At a timing Tb3, the reset gate is turned on by a reset pulse to reset the image data in the floating capacitor. At the same time, only the image data S2n+2, S2n+6, and S2n+10 transferred at the timing Tb2 are further transferred to be added to the image data S2n, S2n+4, and S2n+8, respectively.

At timings Tb4 and Tb5, the added image data are shifted on the shift register. At these timings, as shown in FIG. 10, the image data S2n+S2n+2 is shifted to the floating capacitor to electrically connect a power supply OD to a signal output OS, thereby outputting a signal OS.

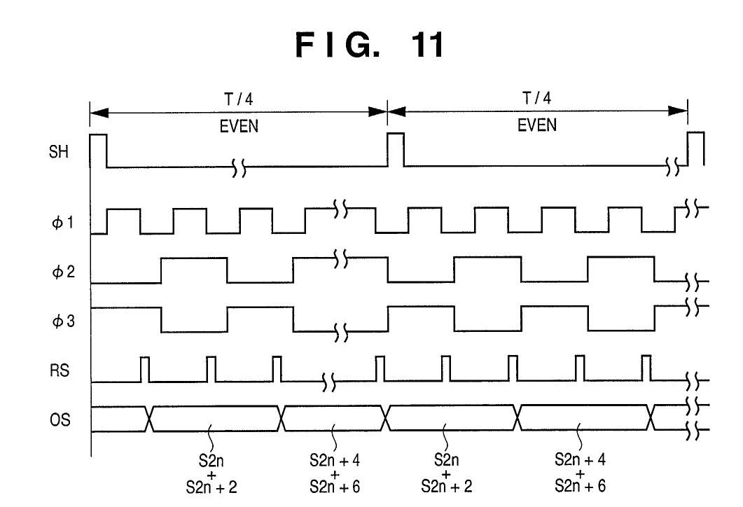

At a timing Tb6, the reset gate is turned on by a reset pulse to reset the image data in the floating capacitor, and the added image data is shifted on the shift register. At timings Tb7 and Tb8, the added image data are shifted on the shift register. As a consequence, the same state as that at the timing Tb2 is set. Subsequently, as the timings are sequentially set, Tb3→Tb4→ . . . , the added image data is sequentially output from the CCD as outputs OS. Thus, data can be output from the CCD as shown in FIG. 11.

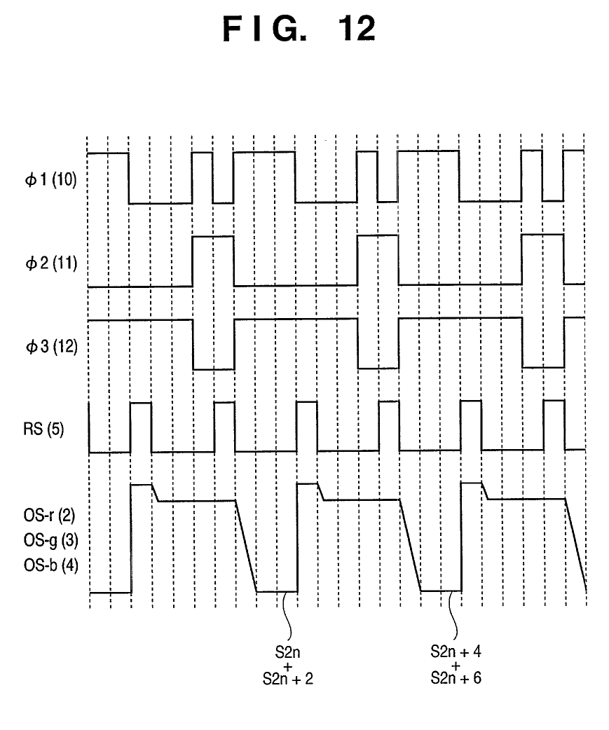

FIG. 12 shows a preferable embodiment of the ¼-resolution read mode. In this preferable embodiment clocks φ1, φ2, φ3, and RS is driven tochange potential state in a cycle of Tb2→Tb3→Tb5→Tb6→Tb2→Tb3→ . . . , in FIG. 9, with an omission of an illustration concerning the timings Tb1, Tb4, Tb7, and Tb8, so that data can be efficiently shifted and the precision in outputting data from the output buffer can be improved when compared with FIG. 9.

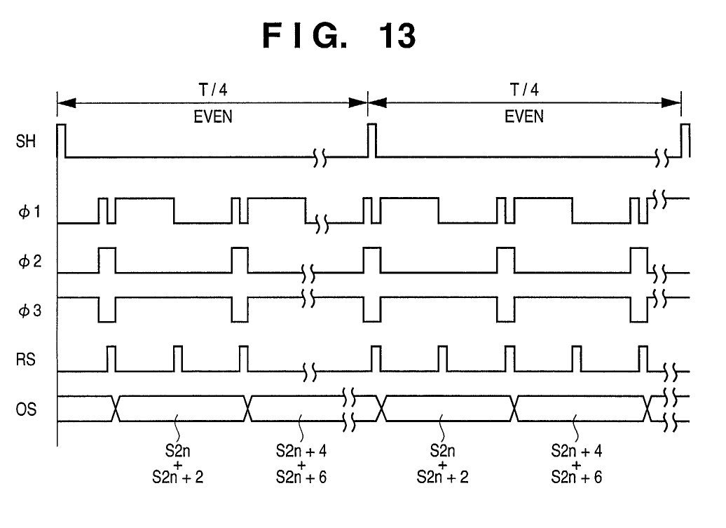

According to the operation of this embodiment, the signals obtained by adding data in adjacent elements in the even-numbered element array is sequentially output as the CCD outputs OS-r, OS-g, and OS-b. By adding adjacent image data, data having a resolution ¼ that of the high-resolution mode is outputted to the RAM for each line, as shown in FIG. 13. This makes it possible to increase the frequencies of the transfer clocks and reset clock by four times and decrease the storage time for each line to ¼ without changing the transfer rate with respect to the RAM. Therefore, image reading operation can be performed with ¼ the resolution at quadruple speed. Even if, a limitation is imposed on the DRAM access time on the digital circuit, and the same CCD output timings as those shown in FIGS. 3 to 5 are required, one line can be read in a time ¼ that of the high-resolution mode.

According to this embodiment, in the color CCD having the staggered arrangement in which the respective elements are shifted from each other by ½P in a staggered pattern, shift registers twice or more in number than photodiodes are arranged, and the transfer clock φ3 is prepared in addition to the transfer clocks φ1 and φ2. In addition, this CCD includes the driving control means for controlling the potential level of the shift register portion with the respective transfer clocks, the reset means which uses a reset pulse to read out image data from either the odd- or even-numbered element array in the low-resolution mode, and the transfer means for performing CCD transfer which allows addition of data in adjacent elements in the shift register portion.

In this case, image data is reset by the reset clock RS to read image data from either the odd- or even-numbered element array. In the low-resolution mode, the time required to read one line is shortened by adding data in elements in the shift register portion in the low-resolution mode without decreasing the S/N ratio.

As described above, in the read mode with a resolution ¼ the basic resolution, the same original can be read in a time ¼ that in the basic resolution mode with a storage time ½0 that in the basic-resolution mode without decreasing the S/N ratio.

With the arrangement shown in FIGS. 7 and 8, the first embodiment can be implemented by inputting the same signals as the signals φ2 and φ3.

That is, the operation in the high-resolution mode and low-resolution mode in the first embodiment shown in FIGS. 3 and 5 can be implemented by using the arrangement of the second embodiment.

As has been described above, according to the above embodiment, the first and second element arrays are shifted from each other by a predetermined width, and data can be read from either the first or second element array. Therefore, data can be read out from either the odd- or even-numbered element array. This makes it possible to satisfy both the requirement for the balance between the storage times in the high-resolution mode and low-resolution mode and the requirement for high-speed reading operation in the low-resolution mode.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
image sensing means which includes a first element array having a plurality of photoelectric conversion elements arranged in a line, and a second element array shifted from the first element array by a predetermined distance in a main scanning direction and having a plurality of photoelectric conversion elements arranged in a line, and outputs signals of the first and second element arrays from a single output portion; and
driving means having a first mode of reading signals from the second element array and continuously outputting the signals from the output portion, and a second mode of reading signals from the first element array and continuously outputting the signals from the output portion.

2. The apparatus according to claim 1, wherein said driving means alternately repeats the first and second modes.

3. The apparatus according to claim 1, wherein said driving means includes operation of alternately repeating the first and second modes and operation of continuously performing the first or second mode.

4. The apparatus according to claim 1, further comprising:
a light source for irradiating an original with light or making light pass through the original; and
imaging means for forming light reflected by the original into an image on said image sensing means while scanning light reflected by the original.

5. The apparatus according to claim 4, further comprising:
analog gain control means for controlling an analog gain of a signal output from said image sensing means; and
an analog/digital converter for digitizing the signal controlled by said analog gain control means.

6. The apparatus according to claim 5, further comprising shading correction means for performing shading correction for the digitized signal.

7. An image processing apparatus comprising:
image sensing means which includes a first element array having a plurality of photoelectric conversion elements arranged in a line, and a second element array shifted from the first element array by a predetermined distance in a main scanning direction and having a plurality of photoelectric conversion elements arranged in a line, and outputs signals of the first and second element arrays from a single output portion; and
driving means for outputting signals from one of the first and second element arrays and resetting signals from the other element array in the output portion.

8. The apparatus according to claim 7, wherein said driving means alternately transfers signals from the first and second element arrays to the output portion, resets the signals from the second element array in the output portion, and continuously and sequentially outputs the signals of the first element array from the output portion.

9. The apparatus according to claim 7, further comprising:
a light source for irradiating an original with light or making light pass through the original; and
imaging means for forming light reflected by the original into an image on said image sensing means while scanning light reflected by the original.

10. The apparatus according to claim 9, further comprising:
analog gain control means for controlling an analog gain of a signal output from said image sensing means; and
an analog/digital converter for digitizing the signal controlled by said analog gain control means.

11. The apparatus according to claim 10, further comprising shading correction means for performing shading correction for the digitized signal.

12. An image processing apparatus comprising:
a first element array having a plurality of photoelectric conversion elements arranged in a line;
a second element array shifted from said first element array by a predetermined distance in a main scanning direction and having a plurality of photoelectric conversion elements arranged in a line;
a first shift register for transferring signals from said first element array;
a second shift register for transferring signals from said second element array; and
an input unit for receiving at least three pulses having different phases and supplying the pulses to said first and second shift registers.

13. The apparatus according to claim 12, wherein said transfer means transfers the signals by using at least three pulses having different phases.

14. The apparatus according to claim 12, further comprising driving means for inputting at least pulses having different phases to said input unit and performing control to add signals from adjacent elements together in said shift register.

15. The apparatus according to claim 12, wherein two pulses having different phases are input to said input unit to output signals from said first and second element arrays without addition.

16. The apparatus according to claim 12, wherein at least three pulses having different phases are input to said input unit to perform control to add signals from adjacent elements in said shift register, and two pulses having different phases are input to said input unit to output signals from said first and second pixel arrays without addition.

17. The apparatus according to claim 12, further comprising:
a light source for irradiating an original with light or making light pass through the original; and
imaging means for forming light reflected by the original into an image on said image sensing means while scanning light reflected by the original.

18. The apparatus according to claim 17, further comprising:
analog gain control means for controlling an analog gain of a signal output from said image sensing means; and
an analog/digital converter for digitizing the signal controlled by said analog gain control means.

19. The apparatus according to claim 18, further comprising shading correction means for performing shading correction for the digitized signal.

20. A processing method for an image processing apparatus including a first element array having a plurality of photoelectric conversion elements arranged in a line, a second element array shifted from the first element array by a predetermined distance in a main scanning direction and having a plurality of photoelectric conversion elements arranged in a line, and output means for outputting signals of the first and second element arrays from a single output portion, comprising the step of reading signals from the second element array and continuously outputting the signals from the output portion or reading signals from the first element array and continuously outputting the signals from the output portion.

21. A processing method for an image processing apparatus including a first element array having a plurality of photoelectric conversion elements arranged in a line, a second element array shifted from the first element array by a predetermined distance in a main scanning direction and having a plurality of photoelectric conversion elements arranged in a line, and output means for outputting signals of the first and second element arrays from a single output portion, comprising the step of outputting signals sent from one of the first and second element arrays from the output portion, and resetting signals from the other element array in the output portion.

22. A processing method for an image processing apparatus including a first element array having a plurality of photoelectric conversion elements arranged in a line, and a second element array shifted from the first element array by a predetermined distance in a main scanning direction and having a plurality of photoelectric conversion elements arranged in a line, comprising the step of transferring signals from the first and second element arrays in accordance with at least three pulses.
